(19) United States
(12) Patent Application Publication
(10) Pub. No.: US 2021/0076852 A1
(43) Pub. Date: Mar. 18, 2021

(54) Pillowcase with leg attachment components for converting a standard pillow into an orthopedic pillow

(71) Applicant: DONNA MARIE PETERSEN, TAMPA, FL (US)

(72) Inventor: DONNA MARIE PETERSEN, TAMPA, FL (US)

(21) Appl. No.: 16/568,270

(22) Filed: Sep. 12, 2019

(51) Int. Cl. A47G 9/10; A47G 9/02

(52) U.S. Cl. CPC A47G 9/1045; A47G 9/0253

(57) ABSTRACT

This invention adds one or more components, called leg attachments, to a standard or custom pillowcase that allow the user to insert a leg through the leg attachment, thus making the pillow wearable, and keeping the pillow in place, between the legs.

### BACKGROUND OF THE INVENTION

A comfortable sleeping position is a key component to gaining deep restful REM sleep, which is so important to every human being's physical, emotional, and psychological health. Sleeping on one's side frequently will help to eliminate or reduce snoring, reduce sleep apnea episodes, and is recommended by doctors worldwide. Sleeping with a pillow between the legs for comfort, spine and hip alignment, is recommended by doctors globally.

With two prosthetic hips and severe obstructive sleep apnea, the inventor sleeps on her side, with a pillow below her legs; every morning the leg pillow can be found on the floor, where it fell when she turned over toward the edge of the bed. With her CPAP machine attached to her face, the pillow was out of reach.

She looked for a pillowcase that attaches to the leg, which you could use your own pillow in, and she could not find one, in the real world, online, or in a patent search, so she created one.

### BRIEF SUMMARY OF THE INVENTION

This invention is to add one or more components to a standard pillowcase, in the manufacture process, compliant with the methods and procedures used in making standard bed linen or clothing. The added components are used to attach the pillowcase, and therefore the pillow, to the leg, keeping the pillow between the legs until the user takes it off. It makes the pillow into a wearable, and it does not fall on the floor, or get lost at the bottom of the bed under the covers. All sleep isn't the same. REM, or rapid eye movement, is an important sleep stage. But the right amount of stage 3 of NREM sleep, also known as deep sleep, is crucial to a good night's sleep and your overall health. Deep sleep helps to restore both your body and your brain. Feeling rested is impossible without the proper amount of deep sleep. By reducing interruptions in sleep, and keeping the user in bed, with their pillow, this pillowcase will improve sleep quality.

### DETAILED DESCRIPTION OF THE INVENTION

This invention allows the user to:
1. Utilize pillows that they already own to create a leg pillow
2. Attach the pillow to the leg, where it stays even when the user turns over, until the user takes it off
3. Take the pillowcase with them when they travel instead of taking bulky knee pillow or buying one at the destination
4. Change the pillow from soft to firm, down alternative or memory foam, for differing levels of support, so that all shapes and sizes of people can make the pillowcase work for them
5. Select from various modifications of the pillowcase, to find the leg attachment style (method/means) that works for them. See drawings for various methods, means and formats of the invention, which is any means used to attach a leg to a pillowcase, to hold the pillow in place.

This invention (add leg attachments to pillowcase) and the pillowcase it is attached to is:

1. Any standard or custom pillowcase size, price point, or quality

2. Any modern material used in the manufacture of bed linens, clothes, etc.

3. Any configuration or number of leg attachments on the pillowcase, including different forms and methods, and on different or multiple sides of the pillowcase

4. Any direction of travel for the leg into the leg attachment, including obliquely

5. The leg attachment components should be comfortable, easy to attach to the leg, use standard haberdashery or linen bedding materials and not detract from all standard pillowcase usages.

This invention is to add one or more components to a standard pillowcase, in the manufacture process, compliant with the methods and procedures used in making standard bed linen or clothing. The added components are used to attach the pillowcase, and therefore the pillow, to the leg, keeping the pillow between the legs until the user takes it off. It makes the pillow into a wearable. The pillow does not fall onto the floor, or get lost under the covers at the bottom of the bed.

The invention can be made in a plethora sizes, configurations, attachments methods (Velcro, elastic, pull ties, clips, etc.), and quality price points. This invention allows the user to try different sizes thicknesses and firmnesses of pillows, using the pillows they own, to find the configuration that they are most comfortable with, without having to buy a different knee to see if it is the right comfort level.

This invention covers all possible configurations, methods, means, manufacturing processes, to make a pillowcase with one or more added components that are used to keep the pillow on the leg, and or attached to its human, and or between the user's legs, and not on the floor or lost under the covers. The invention is not limited to the materials, methods or means of attachment; it is the idea of improving a pillowcase, to add value and usefulness to existing pillows, to be used as leg pillow, including as a knee pillow.

Reference Characters

These are the Reference Characters that are utilized in the drawing files. The legend file shows the visual reference where needed for the Reference Characters.

Reference Characters utilized in the figures, followed by their meaning: Reference Character Meaning

1. Points to the invention, a leg attachment added to a pillowcase

2. Shows one of the directions that the leg can be inserted into the invention

3. Shows utilization of tie pull

4. Shows gathers in material

5. Shows the pillowcase

6. Shows the inside of the pillowcase, where the pillow or pillows are inserted

7. Shows the utilization of elastic

8. Shows the leg sleeve (leg attachment) can be attached in a single seam, as well as in multiple seams

9. Shows the pillowcase can have a zipper or envelop enclosure on the opening where the pillow is inserted

10. {Reserved}

11. Shows that any size pillowcase can be utilized

12. Shows the utilization of Velcro

13. Shows the usage of stretchy, and or mesh material

14. Shows the utilization of a clip

### DRAWINGS

There are three pages of drawings, each in its own file. The drawing files are named and described as follows:

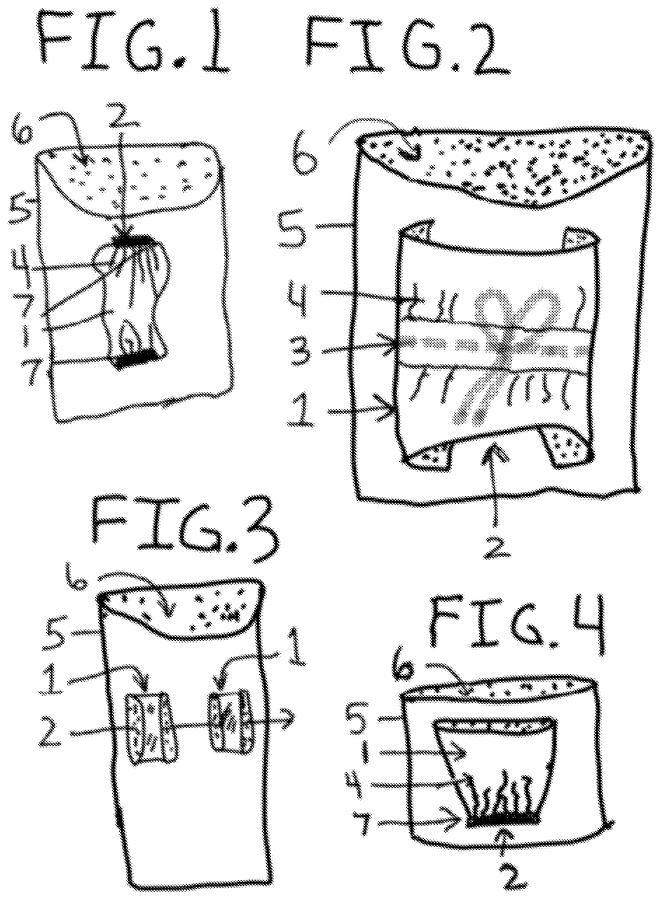

1. Drawing-1.PDF: Contains FIGS. 1 through 4.

a. FIG. 1 depicts the invention of a leg attachment on a standard pillowcase, utilizing elastic at each end of the leg sleeve (leg attachment), to keep the sleeve on the leg, and the pillow attached to the user.

a. FIG. 2 depicts the invention of a leg attachment on a standard pillowcase, utilizing a pull tie on the leg sleeve, to keep the sleeve on the leg, and the pillow attached to the user.

b. FIG. 3 depicts the invention of a leg attachment on a standard king size pillowcase, closer to one end of the pillow, utilizing two smaller leg sleeves, to keep the sleeve on the leg, and the pillow attached to the user. This configuration is a body support, with the king size pillow extending out behind the user, preventing them from rolling onto the back.

c. FIG. 4 depicts the invention of a leg attachment on a standard square pillowcase, utilizing elastic on the leg sleeve, to keep the sleeve on the leg, and the pillow attached to the user. A square pillow allows the user be more comfortable in a fetal position.

2. Drawing-2.PDF: Contains FIGS. 5 through 8.

a. FIG. 5 depicts the invention of a leg attachment on a standard body pillowcase, utilizing elastic on both ends of the leg sleeve, to keep the sleeve on the leg, and the pillow attached to the user. A body pillow allows the user be more comfortable in a plank position, with legs straight.

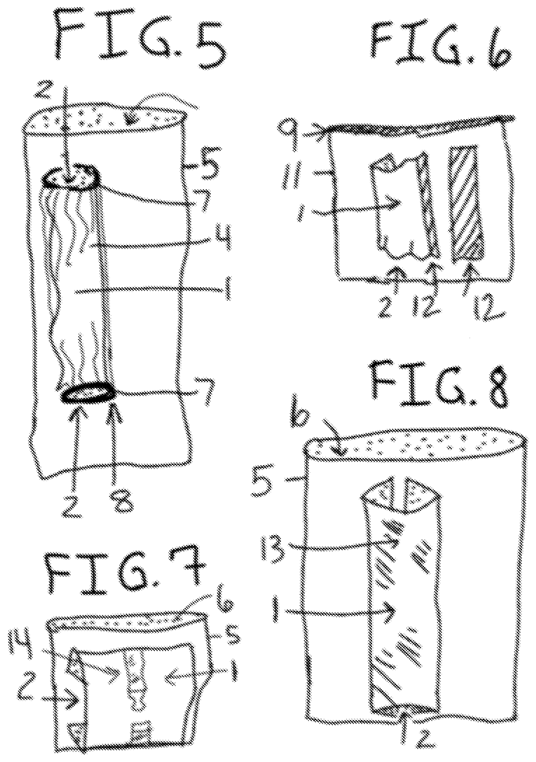

b. FIG. 6 depicts the invention of a leg attachment on a standard square pillowcase, utilizing Velcro on the leg sleeve, to keep the sleeve on the leg, and the pillow attached to the user. A square pillow allows the user be more comfortable in a fetal position.

c. FIG. 7 depicts the invention of a leg attachment on a small square pillowcase, utilizing a clip on the leg sleeve, to keep the sleeve on the leg, and the pillow attached to the user. A small square pillow allows the user be more comfortable in a fetal position, by a smaller person. This could utilize a toss pillow.

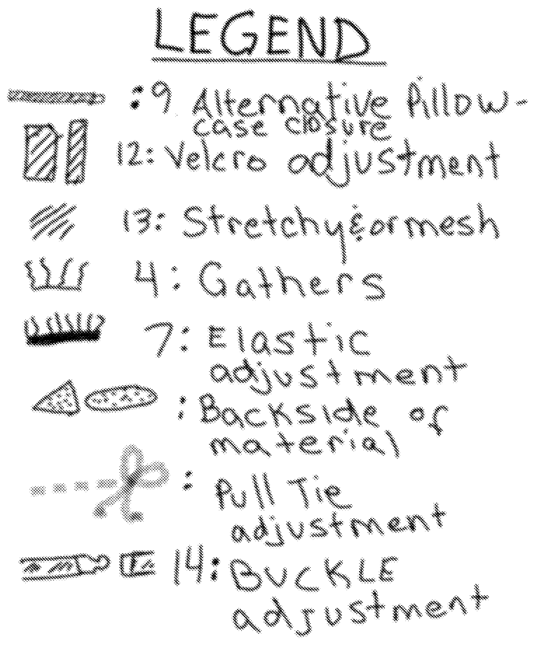

d. FIG. 8 depicts the invention of a leg attachment on a standard pillowcase, utilizing stretchy material on the leg sleeve, to keep the sleeve on the leg, and the pillow attached to the user. The leg sleeve (leg attachment) is made more in the shape of a tube, of stretchy material, and requires no clip, tie, or elastic.

3. Drawing-Legend.PDF: Contains a visual legend describing the drawing reference numbers on FIG. 1 through FIG. 8.

### REFERENCE CHARACTERS

These are the Reference Characters that are utilized in the drawing files. The legend file shows the visual reference where needed for the Reference Characters. Reference Characters utilized in the figures, followed by their meaning:

Reference Character Meaning

1. Points to the invention, a leg attachment added to a pillowcase.

2. Shows one of the directions that the leg can be inserted into the invention.

3. Shows utilization of tie pull.

4. Shows gathers in material

5. Shows the pillowcase

6. Shows the inside of the pillowcase, where the pillow or pillows are inserted.

7. Shows the utilization of elastic.

8. Shows the leg sleeve (leg attachment) can be attached in a single seam, as well as in multiple seams.

9. Shows the pillowcase can have a zipper or envelop enclosure on the opening where the pillow is inserted,

10. {Reserved}

11. Shows that any size pillowcase can be utilized.

12. Shows the utilization of Velcro.

13. Shows the usage of stretchy, and or mesh material.

14. Shows the utilization of a clip.

I claim that this invention:

1. Improves sleep quality by keeping a user's leg/knee pillow attached to the user, and in place between the knees until the user takes it off, so the pillow does not end up on the floor, or lost under the covers, disrupting sleep when the user has to find the pillow.

2. Saves money by allowing the user to utilize pillows they already own to create their own, custom-filled leg pillow, filling it with a pillow of the firmness and height they require to be comfortable sleeping, and changing the inserted pillow whenever they desire.

3. Allows the user to travel with the pillowcase, in a purse or carryon, taking up almost no space, so they can use pillows available at the destination to create their leg pillow, and not have to travel with a bulky knee pillow.

4. Can be used to help enforce side sleeping, and knee pillow usage by and for CPAP users and orthopedic or arthritic users, by using the perpendicular configuration and a larger pillow, the pillow extends behind the user, who cannot then roll onto their back.

5. Helps reduce snoring and sleep apnea episodes by helping to keep the user on their side.
